(19) United States
(12) Patent Application Publication
(10) Pub. No.: US 2023/0026338 A1
(43) Pub. Date: Jan. 26, 2023

(54) Composition Including Fluoropolymer, Benzoyl Peroxide, and Crosslinker and Related Articles and Methods

(71) Applicant: 3M INNOVATIVE PROPERTIES COMPANY, St. Paul, MN (US)

(72) Inventors: Michael H. Mitchell, Edina, MN (US); Tatsuo Fukushi, Woodbury, MN (US)

(21) Appl. No.: 17/783,710

(22) PCT Filed: Dec. 17, 2020
(86) PCT No.: PCT/IB2020/062143

§ 371 Date: Jun. 9, 2022

Related U.S. Application Data
(60) Provisional application No. 62/955,111, filed on Dec. 30, 2019.

(51) Int. Cl. C08K 5/14; C08K 5/00

(52) U.S. Cl. CPC C08K 5/14; C08K 5/0025

(57) ABSTRACT

The composition includes an amorphous fluoropolymer having at least one of bromo- or iodo-cure sites, benzoyl peroxide, and a crosslinker comprising more than one carbon-carbon double bond. Benzoyl peroxide is present in an amount of three to four parts per hundred parts of fluoropolymer in the composition, and the benzoyl peroxide is present in an amount greater than or equal to that of the crosslinker. An article made from the composition and a method of making a fluoroelastomer are also disclosed.

### CROSS-REFERENCE TO RELATED APPLICATION

This application claims priority to U.S. Provisional Application No. 62/955,111, filed Dec. 30, 2019, the disclosure of which is incorporated by reference in its entirety herein.

### BACKGROUND

Fluoroelastomers are known to have excellent mechanical properties, heat resistance, weather resistance, and chemical resistance, for example. Such beneficial properties render fluoroelastomers useful for example, as O-rings, seals, hoses, skid materials, and coatings (e.g., metal gasket coating for automobiles). Fluoroelastomers have been found useful in the automotive, chemical processing, semiconductor, aerospace, and petroleum industries, among others.

Fluoroelastomers are typically prepared by combining an amorphous fluoropolymer, sometimes referred to as a fluoroelastomer gum, with one or more curatives, shaping the resulting curable composition into a desired shape, and curing the curable composition. The amorphous fluoropolymer often includes a cure site, which is a functional group incorporated into the amorphous fluoropolymer backbone capable of reacting with a certain curative.

Benzoyl peroxide has been demonstrated to cure certain amorphous fluoropolymers to make fluoroelastomers. See, for example, U.S. Pat. 2,833,752 (Honn et al.) and Int. Pat. Appl. Pub. No. WO 2014/071129 (Fukushi); 2010/147815 (Fukushi et al.); and 2017/216035 (Fantoni et al.).

### SUMMARY

The present disclosure provides compositions and articles that include a fluoropolymer, benzoyl peroxide, and a crosslinker. Typically and unexpectedly, fluoroelastomers prepared from the compositions having a relatively high amount of benzoyl peroxide have significantly improved compression sets compared to fluoroelastomers prepared from compositions having lower levels of benzoyl peroxide or 2,5-dimethyl-2,5-di(t-butylperoxy)-hexane.

In one aspect, the present disclosure provides a composition that includes a fluoropolymer having at least one of bromo- or iodo-cure sites, benzoyl peroxide, and a crosslinker comprising more than one carbon-carbon double bond. The benzoyl peroxide is present in an amount of three to four parts per hundred parts of fluoropolymer in the composition, and the benzoyl peroxide is present at a weight percent greater than or equal to that of the crosslinker. The fluoropolymer may be semi-crystalline. The fluoropolymer may have a Mooney viscosity (ML 1+10) at 100° C. of greater than 2.1. The composition may further comprise carbon black (e.g., medium thermal black or a large-particle-size furnace blacks).

In another aspect, the present disclosure provides an article made by curing the composition.

In another aspect, the present disclosure provides a method of making a cured fluoroelastomer. The method includes providing the composition disclosed herein and heating the curable composition to make the cured fluoroelastomer.

In this application:

Terms such as “a”, “an” and “the” are not intended to refer to only a singular entity but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list. The phrase “at least one of” followed by a list refers to any one of the items in the list or any combination of two or more items in the list.

The term “aliphatic” refers to being non-aromatic. This term is used to encompass alkyl, alkenyl, and alkynyl groups, for example.

The term “alkyl” refers to a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Cyclic groups can be monocyclic or polycyclic and typically have from 3 to 10 ring carbon atoms. Examples of “alkyl” groups include methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, adamantyl, and norbornyl.

The term “alkylene” is the divalent or trivalent form of the “alkyl” groups defined above.

The term “aryl” refers to a monovalent group that is aromatic and, optionally, carbocyclic. The aryl has at least one aromatic ring. Any additional rings can be unsaturated, partially saturated, saturated, or aromatic. Optionally, the aromatic ring can have one or more additional carbocyclic rings that are fused to the aromatic ring. Unless otherwise indicated, the aryl groups typically contain from 6 to 30 carbon atoms and optionally contain at least one heteroatom (i.e., O, N, or S). In some embodiments, the aryl groups contain 6 to 20, 6 to 18, 6 to 16, 6 to 12, or 6 to 10 carbon atoms. Examples of an aryl group include phenyl, naphthyl, biphenyl, phenanthryl, anthracyl, and pyridinyl.

The term “arylene” is the divalent form of the “aryl” groups defined above.

The terms “cure” and “curable” joining polymer chains together by covalent chemical bonds, usually via crosslinking molecules or groups, to form a network polymer. Therefore, in this disclosure the terms “cured” and “crosslinked” may be used interchangeably. A cured or crosslinked polymer is generally characterized by insolubility but may be swellable in the presence of an appropriate solvent.

The phrase “interrupted by at least one —O— group”, for example, with regard to a perfluoroalkyl or perfluoroalkylene group refers to having part of the perfluoroalkyl or perfluoroalkylene on both sides of the —O— group. For example, —CF₂CF₂—O—CF₂—CF₂— is a perfluoroalkylene group interrupted by an ——O—.

The term “halogen” refers to a halogen atom or one or more halogen atoms, including chlorine, bromine, iodine, and fluorine atoms or fluoro, chloro, bromo, or iodo substituents.

The term “fluoro-” (for example, in reference to a group or moiety, such as in the case of “fluoroalkylene” or “fluoroalkyl” or “fluorocarbon”) or “fluorinated” can mean partially fluorinated such that there is at least one carbon-bonded hydrogen atom or perfluorinated.

The term “perfluoro-” (for example, in reference to a group or moiety, such as in the case of “perfluoroalkylene” or “perfluoroalkyl” or “perfluorocarbon”) or “perfluorinated” means completely fluorinated such that, except as may be otherwise indicated, there are no carbon-bonded hydrogen atoms replaceable with fluorine.

All numerical ranges are inclusive of their endpoints and nonintegral values between the endpoints unless otherwise stated (e.g., 1 to 5 includes 1, 1.5, 2, 2.75, 3, 3.80, 4, 5, etc.).

### DETAILED DESCRIPTION

The composition of the present disclosure includes at least one fluoropolymer. In some embodiments, the composition contains at least 50% by weight, at least 75%, at least 80%, at least 90%, or even at least 95% by weight fluoropolymer(s) based on the total weight of the composition.

The fluoropolymer useful in the composition, article, and method of the present disclosure may have a partially or fully fluorinated backbone. Suitable fluoropolymers include those that have a backbone that is at least 30% by weight fluorinated, at least 50% by weight fluorinated, and in some embodiments at least 65% by weight fluorinated; these percentages indicate the weight percent contributed by fluorine atoms in the fluoropolymer. Fluoropolymers useful for practicing the present disclosure may include one or more interpolymerized units derived from at least two principal monomers. Examples of suitable fluorinated monomers include perfluoroolefins (e.g., tetrafluoroethylene (TFE) and hexafluoropropylene (HFP), or any perfluoroolefin of the formula CF₂═CF—Rf, where Rf is fluorine or a perfluoroalkyl of 1 to 8, in some embodiments 1 to 3, carbon atoms), perfluorovinyl ethers (e.g., perfluoroalkyl vinyl ethers (PAVE) and perfluoroalkoxyalkyl vinyl ethers (PAOVE)), perfluoroallyl ethers (e.g., perfluoroalkyl allyl ethers and perfluoroalkoxyalkyl allyl ethers), halogenated fluoroolefins (e.g., trifluorochloroethylene (CTFE), 2-chloropentafluoropropene, and dichlorodifluoroethylene), and partially fluorinated olefins (e.g., vinylidene fluoride (VDF), vinyl fluoride, pentafluoropropylene, and trifluoroethylene). Suitable non-fluorinated comonomers include vinyl chloride, vinylidene chloride, and C₂-C₈ olefins (e.g., ethylene and propylene).

In some embodiments, the fluoropolymer useful in the composition, method, and article of the present disclosure includes units from one or more monomers independently represented by formula CF₂═CF(CF₂)ₘ(OCₙF₂ₙ)_{z}OR_{f}², wherein R_{f}² is a linear or branched perfluoroalkyl group having from 1 to 8 carbon atoms and uninterrupted or interrupted by one or more —O— groups; z is 0, 1, or 2; each n is independently 1, 2, 3, or 4; m is 0 or 1. Suitable monomers of this formula include those in which m and z are 0, and the perfluoroalkyl perfluorovinyl ethers are represented by formula CF₂═CFOR_{f}², wherein R_{f}² is perfluoroalkyl having from 1 to 8, 1 to 4, or 1 to 3 carbon atoms, optionally interrupted by one or more —O— groups. Perfluoroalkoxyalkyl vinyl ethers suitable for making a fluoropolymer include those represented by formula CF₂═CF(CF₂)ₘ(OCₙF₂ₙ)_{z}OR_{f}², in which m is 0, each n is independently from 1 to 6, z is 1 or 2, and R_{f}² is a linear or branched perfluoroalkyl group having from 1 to 8 carbon atoms and optionally interrupted by one or more —O— groups. In some embodiments, n is from 1 to 4, or from 1 to 3, or from 2 to 3, or from 2 to 4. In some embodiments, n is 1 or 3. In some embodiments, n is 3. CₙF₂ₙ may be linear or branched. In some embodiments, CₙF₂ₙ can be written as (CF₂)ₙ, which refers to a linear perfluoroalkylene group. In some embodiments, CₙF₂ₙ is —CF₂—CF₂—CF₂—. In some embodiments, CₙF₂ₙ is branched, for example, —CF₂—CF(CF₃)—. In some embodiments, (OCₙF₂ₙ)_{z} is represented by —O—(CF₂)₁₋₄-[O(CF₂)₁₋₄]₀₋₁. In some embodiments, R_{f}² is a linear or branched perfluoroalkyl group having from 1 to 8 (or 1 to 6) carbon atoms that is optionally interrupted by up to 4, 3, or 2 —O— groups. In some embodiments, R_{f}² is a perfluoroalkyl group having from 1 to 4 carbon atoms optionally interrupted by one —O— group. Suitable monomers represented by formula CF₂═CFOR_{f}² and CF₂═CF(OCₙF₂ₙ)_{z}OR_{f}² include perfluoromethyl vinyl ether (PMVE), perfluoroethyl vinyl ether (PEVE), perfluoropropyl vinyl ether (PPVE), CF₂═CFOCF₂OCF₃, CF₂═CFOCF₂OCF₂CF₃, CF₂═CFOCF₂CF₂OCF₃,

CF₂═CFOCF₂CF₂CF₂OCF₃, CF₂═CFOCF₂CF₂CF₂CF₂OCF₃, CF₂═CFOCF₂CF₂OCF₂CF₃,
CF₂═CFOCF₂CF₂CF₂OCF₂CF₃, CF₂═CFOCF₂CF₂CF₂CF₂OCF₂CF₃, CF₂═CFOCF₂CF₂OCF₂OCF₃,
CF₂═CFOCF₂CF₂OCF₂CF₂OCF₃, CF₂═CFOCF₂CF₂OCF₂CF₂CF₂OCF₃,
CF₂═CFOCF₂CF₂OCF₂CF₂CF₂CF₂OCF₃, CF₂═CFOCF₂CF₂OCF₂CF₂CF₂CF₂CF₂OCF₃,
CF₂═CFOCF₂CF₂(OCF₂)₃OCF₃, CF₂═CFOCF₂CF₂(OCF₂)₄OCF₃, CF₂═CFOCF₂CF₂OCF₂OCF₂OCF₃,
CF₂═CFOCF₂CF₂OCF₂CF₂CF₃ CF₂═CFOCF₂CF₂OCF₂CF₂OCF₂CF₂CF₃, CF₂═CFOCF₂CF(CF₃)—O—C₃F₇ (PPVE-2), CF₂═CF(OCF₂CF(CF₃))₂—O—C₃F₇ (PPVE-3), and CF₂═CF(OCF₂CF(CF₃))₃—O—C₃F₇ (PPVE-4). Many of these perfluoroalkoxyalkyl vinyl ethers can be prepared according to the methods described in U.S. Pat. No. 6,255,536 (Worm et al.) and U.S. Pat. No. 6,294,627 (Worm et al.).

Suitable fluoro (alkene ether) monomers include those described in U.S. Pat. No. 5,891,965 (Worm et al.) and U.S. Pat. No. 6,255,535 (Schulz et al.). Such monomers include those in which n is 0 and which are represented by formula CF₂═CF(CF₂)ₘ—O—R_{f}², wherein m is 1, and wherein R_{f}² is as defined above in any of its embodiments. Suitable perfluoroalkoxyalkyl allyl ethers include those represented by formula CF₂═CFCF₂(OCₙF₂ₙ)_{z}ORf₂, in which n, z, and Rf₂ are as defined above in any of the embodiments of perfluoroalkoxyalkyl vinyl ethers. Examples of suitable perfluoroalkoxyalkyl allyl ethers include

CF₂═CFCF₂OCF₂CF₂OCF₃, CF₂═CFCF₂OCF₂CF₂CF₂OCF₃, CF₂═CFCF₂OCF₂OCF₃,
CF₂═CFCF₂OCF₂OCF₂CF₃, CF₂═CFCF₂OCF₂CF₂CF₂CF₂OCF₃, CF₂═CFCF₂OCF₂CF₂OCF₂CF₃,
CF₂═CFCF₂OCF₂CF₂CF₂OCF₂CF₃, CF₂═CFCF₂OCF₂CF₂CF₂CF₂OCF₂CF₃,
CF₂═CFCF₂OCF₂CF₂OCF₂OCF₃, CF₂═CFCF₂OCF₂CF₂OCF₂CF₂OCF₃,
CF₂═CFCF₂OCF₂CF₂OCF₂CF₂CF₂OCF₃, CF₂═CFCF₂OCF₂CF₂OCF₂CF₂CF₂CF₂OCF₃,
CF₂═CFCF₂OCF₂CF₂OCF₂CF₂CF₂CF₂CF₂OCF₃, CF₂═CFCF₂OCF₂CF₂(OCF₂)₃OCF₃,
CF₂═CFCF₂OCF₂CF₂(OCF₂)₄OCF₃, CF₂═CFCF₂OCF₂CF₂OCF₂OCF₂OCF₃,
CF₂═CFCF₂OCF₂CF₂OCF₂CF₂CF₃, CF₂═CFCF₂OCF₂CF₂OCF₂CF₂OCF₂CF₂CF₃,
CF₂═CFCF₂OCF₂CF(CF₃)—O—C₃F₇, and CF₂═CFCF₂(OCF₂CF(CF₃))₂——C₃F₇. Many of these perfluoroalkoxyalkyl allyl ethers can be prepared, for example, according to the methods described in U.S. Pat. No. 4,349,650 (Krespan).

The fluoropolymer useful in the composition, article, and method of the present disclosure is typically an amorphous fluoropolymer. Amorphous fluoropolymers typically do not exhibit a melting point and exhibit little or no crystallinity at room temperature. Useful amorphous fluoropolymers can have glass transition temperatures below room temperature or up to 280° C. Suitable amorphous fluoropolymers can have glass transition temperatures in a range from −60° C. up to 280° C., −60° C. up to 250° C., from −60° C. to 150° C., from −40° C. to 150° C., from −40° C. to 100° C., or from −40° C. to 20° C. Amorphous fluoropolymers include, for example, copolymers of at least one terminally ethylenically-unsaturated fluoromonomer containing at least one fluorine atom substituent on each double-bonded carbon atom, each carbon atom of said fluoromonomer being substituted only with fluorine and optionally with chlorine, hydrogen, a lower fluoroalkyl radical, or a lower fluoroalkoxy radical. Specific examples of copolymers include copolymers having interpolymerized units of a combination of monomers as follows: VDF-HFP, TFE-propylene, VDF-TFE-HFP, VDF-TFE-PAVE, TFE-PAVE, ethylene-TFE-PAVE and any of the aforementioned copolymers further including units derived from a chlorine containing monomer such as CTFE. Still further examples of suitable amorphous copolymers include CTFE-propylene.

Those skilled in the art are capable of selecting specific interpolymerized units at appropriate amounts to form an amorphous fluoropolymer. In some embodiments, the amorphous fluoropolymers comprise from 20 to 85%, in some embodiments, 50 to 80% by moles of repeating units derived from VDF and TFE, which may be copolymerized with one or more other fluorinated ethylenically unsaturated monomer, such as HFP and/or one or more non-fluorinated C₂-C₈ olefins, such as ethylene and propylene. When included, the units derived from the fluorinated ethylenically unsaturated comonomer are generally present at between 5 and 45 mole %, e.g., between 10 and 40 mole %, based on the total moles of comonomers in the fluoropolymer. When included, the units derived from the non-fluorinated comonomers are generally present at between 1 and 50 mole %, e.g., between 1 and 30 mole %, based on the total moles of comonomers in the fluoropolymer.

When the amorphous fluoropolymer is perhalogenated, in some embodiments perfluorinated, typically at least 50 mole percent (mol %) of its interpolymerized units are derived from TFE and/or CTFE, optionally including HFP. The balance of the interpolymerized units of the amorphous fluoropolymer (10 to 50 mol %) is made up of one or more perfluoroalkyl vinyl ethers and/or perfluoroalkoxyalkyl vinyl ethers, and a suitable cure site monomer. When the fluoropolymer is not perfluorinated, it typically contains from about 5 mol % to about 95 mol % of its interpolymerized units derived from TFE, CTFE, and/or HFP, from about 5 mol % to about 90 mol % of its interpolymerized units derived from VDF, ethylene, and/or propylene, up to about 40 mol % of its interpolymerized units derived from a vinyl ether, and from about 0.1 mol % to about 5 mol %, in some embodiments from about 0.3 mol % to about 2 mol %, of a suitable cure site monomer.

Examples of amorphous fluoropolymers useful in the compositions and articles of the present disclosure include a TFE/propylene copolymer, a TFE/propylene/VDF copolymer, a VDF/HFP copolymer, a TFE/VDF/HFP copolymer, a TFE/PMVE copolymer, a TFE/CF₂═CFOC₃F₇ copolymer, a TFE/CF₂═CFOCF₃/CF₂═CFOC₃F₇ copolymer, a TFE/ethyl vinyl ether (EVE) copolymer, a TFE/butyl vinyl ether (BVE) copolymer, a TFE/EVE/BVE copolymer, a VDF/CF₂═CFOC₃F₇ copolymer, an ethylene/HFP copolymer, a TFE/HFP copolymer, a CTFE/VDF copolymer, a TFE/VDF copolymer, a TFE/VDF/PMVE/ethylene copolymer, and a TFE/VDF/CF₂═CFO(CF₂)₃OCF₃ copolymer.

Fluoropolymers useful for practicing the present disclosure (e.g., amorphous fluoropolymers) may have a Mooney viscosity in a range from 0.1 to 100 (ML 1+10) at 100° C. according to ASTM D1646-06 TYPE A. In some embodiments, fluoropolymers useful for practicing the present disclosure have a Mooney viscosity in a range from 0.1 to 50, 0.1 to 25, 0.1 to 20, 0.1 to 10, or 0.1 to 5 (ML 1+10) at 100° C. according to ASTM D1646-06 TYPE A. In some embodiments, the fluoropolymer has a Mooney viscosity (ML 1+10) at 100° C. of greater than 2.1 and up to 50 or greater than 4 and up to 25. In some embodiments, the fluoropolymer has a Mooney viscosity (ML 1+10) at 121° C. of up to 100. In some embodiments, the fluoropolymer has a Mooney viscosity (ML 1+10) at 121° C. in a range from 15 to 60 or in a range from 20 to 50.

Fluoropolymers can include a cure site to render them curable. The fluoropolymer useful in the composition, article, and method of the present disclosure has at least one of bromo- or iodo-cure sites. In some of these embodiments, the fluoropolymer comprises an iodo-cure site. The cure site can be an iodo- or bromo-group chemically bonded at the end of a fluoropolymer chain. The weight percent of elemental iodine or bromine in the fluoropolymer may range from about 0.2 wt. % to about 2 wt. %, and, in some embodiments, from about 0.3 wt. % to about 1 wt. %, based on the total weight of the fluoropolymer. To incorporate a cure site end group into the amorphous fluoropolymer, any one of an iodo-chain transfer agent or a bromo-chain transfer agent can be used in the polymerization process. For example, suitable iodo-chain transfer agents include perfluoroalkyl or chloroperfluoroalkyl groups having 3 to 12 carbon atoms and one or two iodo-groups. Examples of iodo-perfluoro-compounds include 1,3-diiodoperfluoropropane, 1,4-diiodoperfluorobutane, 1,6-diiodoperfluorohexane, 1,8-diiodoperfluorooctane, 1,10-diiodoperfluorodecane, 1,12-diiodoperfluorododecane, 2-iodo-1,2-dichloro-1,1,2-trifluoroethane, 4-iodo-1,2,4-trichloroperfluorobutane and mixtures thereof. Suitable bromo-chain transfer agents include perfluoroalkyl or chloroperfluoroalkyl groups having 3 to 12 carbon atoms and one or two bromo-groups.

Bromo- and iodo-cure site monomers may also be incorporated into the fluoropolymer by including cure site monomers in the polymerization reaction. Examples of cure site monomers include those of the formula CX₂═CX(Z), wherein each X is independently H or F, and Z is I, Br, or R_{f}—Z, wherein Z is I or Br and R_{f} is a perfluorinated or partially perfluorinated alkylene group optionally containing O atoms. In addition, non-fluorinated bromo- or iodo-substituted olefins, e.g., vinyl iodide and allyl iodide, can be used. In some embodiments, the cure site monomers is CH₂═CHI, CF₂═CHI, CF₂═CFI, CH₂═CHCH₂I, CF₂═CFCF₂I, CH₂═CHCF₂CF₂I, CF₂═CFCH₂CH₂I, CF₂═CFCF₂CF₂I, CH₂═CH(CF₂)₆CH₂CH₂I, CF₂═CFOCF₂CF₂I, CF₂═CFOCF₂CF₂CF₂I, CF₂═CFOCF₂CF₂CH₂I, CF₂═CFCF₂OCH₂CH₂I, CF₂═CFO(CF₂)₃OCF₂CF₂I, CH₂═CHBr, CF₂═CHBr, CF₂═CFBr, CH₂═CHCH₂Br, CF₂═CFCF₂Br, CH₂═CHCF₂CF₂Br, CF₂═CFOCF₂CF₂Br, or a mixture thereof.

The chain transfer agents having the cure site and/or the cure site monomers can be fed into the reactor by batch charge or continuously feeding. Because feed amount of chain transfer agent and/or cure site monomer is relatively small compared to the monomer feeds, continuous feeding of small amounts of chain transfer agent and/or cure site monomer into the reactor is difficult to control. Continuous feeding can be achieved by a blend of the iodo-chain transfer agent in one or more monomers. Examples of monomers useful for such a blend include hexafluoropropylene (HFP) and perfluoromethyl vinyl ether (PMVE).

In some embodiments, the fluoropolymer useful in the compositions and articles of the present disclosure is a thermoplastic fluoropolymer. Useful thermoplastic fluoropolymers are typically semi-crystalline and melt processable with melt flow indexes in a range from 0.01 grams per ten minutes to 10,000 grams per ten minutes (20 kg/372° C.). Suitable semi-crystalline fluoropolymers can have melting points in a range from 50° C. up to 325° C., from 100° C. to 325° C., from 150° C. to 325° C., from 100° C. to 300° C., or from 80° C. to 290° C. A semi-crystalline fluoropolymer, when evaluated by differential scanning calorimetry (DSC), typically has at least one melting point temperature (Tₘ) of at least 50° C., at least 60° C., or at least 70° C. and a measurable enthalpy, for example, greater than 0 J/g, or even greater than 0.01 J/g. The enthalpy is determined by the area under the curve of the melt transition as measured by DSC using the method described in U.S. Pat. Appl. Pub. No. 2018/0208743 (Fukushi et al.) and expressed as Joules/gram (J/g). Any of the monomers described above can be useful for making fluoropolymers can be useful for making thermoplastic fluoropolymers, and a person skilled in the art is capable of selecting specific interpolymerized units at appropriate amounts to form a semi-crystalline fluoropolymer.

In some embodiments, the semi-crystalline fluoropolymer useful for practicing the present disclosure is a random fluorinated copolymer having units derived from at least the following monomers: tetrafluoroethylene (TFE), hexafluoropropylene (HFP), and vinylidene fluoride (VDF). In some embodiments, the fluoropolymer is derived at least 20, 25 or even 30 wt. % and at most 40, 50, 55, or even 60 wt. % TFE; at least 10, 15, or even 20 wt. % and at most 25 or even 30 wt. % HFP; and at least 15, 20, or even 30 wt. % and at most 50, 55, or even 60 wt. % VDF. In some embodiments, the semi-crystalline fluoropolymer has a Melt Flow Index (MFI) greater than 5, 5.5, 6, or even 7 g/10 min at 265° C. and 5 kg. MFI or Melt Flow Rate (MFR) can be used as a measure of the ease of the melt of a fluorothermoplastic polymer to flow. As MFI is higher, flow is better. MFI is also an indirect measurement of molecular weight. As MFI is higher, the molecular weight is lower.

Further examples of thermoplastic fluoropolymers include copolymers having units from a combination of the following monomers: VDF-CTFE, CTFE-TFE-P, VDF-CTFE-HFP, CTFE-TFE-PVE, and CTFE-E-TFE-PVE.

In some embodiments, the semi-crystalline fluoropolymer useful in the compositions and articles of the present disclosure is a block copolymer having at least one semi-crystalline block. In some embodiments, the block copolymer includes at least A and B blocks in which the A block is a copolymer having units derived from at least the following monomers: tetrafluoroethylene (TFE), hexafluoropropylene (HFP), and vinylidene fluoride (VDF). In some embodiments, the A block comprises 30 wt. % to 85 wt. % TFE; 5 wt. % to 40 wt. % HFP; and 5 wt. % to 55 wt. % VDF; 30 wt. % to 75 wt. % TFE; 5 wt. % to 35 wt. % HFP; and 5 wt. % to 50 wt. % VDF; or even 40 wt. % to 70 wt. % TFE; 10 wt. % to 30 wt. % HFP; and 10 wt. % to 45 wt. % VDF. The B block is a copolymer derived from at least the following monomers: hexafluoropropylene (HFP), and vinylidene fluoride (VDF). In some embodiments, the B block comprises 25 wt. % to 65 wt. % VDF and 15 wt. % to 60 wt. % HFP; or even 35 wt. % to 60 wt. % VDF and 25 wt. % to 50 wt. % HFP. Further details regarding such block copolymers and methods of making them can be found in U.S. Pat. Appl. Publ. No. 2018/0194888 (Mitchell et al.).

Other fluorinated block copolymers having at least one semi-crystalline segment may also be useful in the compositions and articles of the present disclosure. In some embodiments, the A block is a copolymer having units derived from TFE and a perfluoroolefin, for example, having 2 to 8 carbon atoms (e.g., hexafluoropropylene (HFP)). Generally, these perfluoroolefins are used in amounts of at least 2 wt. %, 3, wt. % or 4 wt. % and at most 5 wt. %, 10 wt. %, 15 wt. %, or 20 wt. %. Other comonomers may be added in small amounts (e.g., less than 0.5 wt. %, 1 wt. %, 2 wt. %, 3 wt. %, or 5 wt. %). Such comonomers can include fluorinated vinyl and allyl ethers as described above. In some embodiments, the A block is a copolymer having units derived from TFE or CTFE (e.g., at least 40 wt. % or 45 wt. %; and at most 50 wt. %, 55 wt. %, or 60 wt. %) and a non-fluorinated olefin (e.g., at least 40 wt. % or 45 wt. %; and at most 50 wt. %, 55 wt. %, or 60 wt. %). Such non-fluorinated olefins comprise 2 to 8 carbon atoms (e.g., ethylene, propylene, and isobutylene). Other comonomers may be added in small amounts (e.g., at least 0.1 wt. %, 0.5 wt. %, or 1 wt. % and at most 3 wt. %, 5 wt. %, 7 wt. %, or 10 wt. %). Such comonomers can include fluorinated olefins (e.g., VDF or HFP) and fluorinated vinyl and allyl ethers as described above. In some embodiments, the A block is a copolymer having units derived from VDF;

derived from only VDF or VDF and small amounts (e.g., at least 0.1 wt. %, 0.3 wt. %, or 0.5 wt. % and at most 1 wt. %, 2 wt. %, 5 wt. %, or 10 wt. %) of other fluorinated comonomers such as fluorinated olefins such as HFP, TFE, and trifluoroethylene.

The thermoplastic fluoropolymer useful for the compositions and articles of the present disclosure, including any of the embodiments of the semi-crystalline fluoropolymers described above, include at least one of iodo- or bromo-cure sites. The cure sites can be incorporated into the fluoropolymer using the cure site monomers and/or chain transfer agents described above in any of their embodiments. In some embodiments, thermoplastic fluoropolymer includes at least 0.05 wt. %, at least 0.1 wt. %, or at least 0.5 wt. % and at most 0.8 wt. % or at most 1 wt. % elemental bromine or iodine based on the weight of the fluoropolymer.

Curable block copolymers including cyano-cure sites or incorporated bisolefin monomers as described in Int. Pat. Appl. Pub. Nos. W02018/136324 (Mitchell et al.) and WO 2018/136331 (Mitchell et al.) may also be useful semi-crystalline fluoropolymers for the compositions and articles of the present disclosure.

Several amorphous and semi-crystalline fluoropolymers useful for practicing the present disclosure are commercially available.

A fluoropolymer is typically prepared by a sequence of steps, which can include polymerization, coagulation, washing, and drying. In some embodiments, an aqueous emulsion polymerization can be carried out continuously under steady-state conditions. In this embodiment, for example, an aqueous emulsion of monomers (e.g., including any of those described above), water, emulsifiers, buffers and catalysts are fed continuously to a stirred reactor under optimum pressure and temperature conditions while the resulting emulsion or suspension is continuously removed. In some embodiments, batch or semibatch polymerization is conducted by feeding the aforementioned ingredients into a stirred reactor and allowing them to react at a set temperature for a specified length of time or by charging ingredients into the reactor and feeding the monomers into the reactor to maintain a constant pressure until a desired amount of polymer is formed. After polymerization, unreacted monomers are removed from the reactor effluent latex by vaporization at reduced pressure. The fluoropolymer can be recovered from the latex by coagulation.

The polymerization is generally conducted in the presence of a free radical initiator system, such as ammonium persulfate. The polymerization reaction may further include other components such as chain transfer agents and complexing agents. The polymerization is generally carried out at a temperature in a range from 10° C. and 100° C., or in a range from 30° C. and 80° C. The polymerization pressure is usually in the range of 0.3 MPa to 30 MPa, and in some embodiments in the range of 2 MPa and 20 MPa.

Adjusting, for example, the concentration and activity of the initiator, the concentration of each of the reactive monomers, the temperature, the concentration of the chain transfer agent, and the solvent using techniques known in the art can control the molecular weight of the amorphous fluoropolymer. In some embodiments, amorphous fluoropolymers useful for practicing the present disclosure have weight average molecular weights in a range from 10,000 grams per mole to 200,000 grams per mole. In some embodiments, the weight average molecular weight is at least 15,000, 20,000, 25,000, 30,000, 40,000, or 50,000 grams per mole up to 100,000, 150,000, 160,000, 170,000, 180,000, or up to 190,000 grams per mole. Amorphous fluoropolymers disclosed herein typically have a distribution of molecular weights and compositions. Weight average molecular weights can be measured, for example, by gel permeation chromatography (i.e., size exclusion chromatography) using techniques known to one of skill in the art.

The fluoropolymers useful in the composition and article of the present disclosure are curable by a peroxide curing reaction. This means the fluoropolymers are curable by one or more peroxide curing agents or the radicals generated by the peroxide curing agents. The composition of the present disclosure and/or useful for practicing the present disclosure includes benzoyl peroxide. The benzoyl peroxide is present in the composition or first composition in an amount effective to cure the composition. In some embodiments, the weight ratio of the benzoyl peroxide to the at least one of bromine to iodine cure sites is in a range from 3 to 40. In some embodiments, the benzoyl peroxide is present in the composition in a range from 3% by weight to 4% by weight based on the weight of the fluoropolymer in the composition.

The composition of the present disclosure and/or useful for practicing the present disclosure includes a crosslinker, which may be useful, for example, for providing enhanced mechanical strength in the final cured articles. The crosslinker includes more than one carbon-carbon double bond. Examples of useful crosslinkers include tri(methyl)allyl isocyanurate (TMAIC), triallyl isocyanurate (TAIC), tri(methyl)allyl cyanurate, poly-triallyl isocyanurate (poly-TAIC), xylylene-bis(diallyl isocyanurate) (XBD), N,N′-m-phenylene bismaleimide, diallyl phthalate, tris(diallylamine)-s-triazine, triallyl phosphite, diallyl ether of glycerin, triallylphosphate, diallyl adipate, diallylmelamine, 1,2-polybutadiene, ethyleneglycol diacrylate, diethyleneglycol diacrylate, and CH₂═CH—R_{f1}—CH═CH₂, wherein R_{f1} is a perfluoroalkylene having from 1 to 8 carbon atoms. The crosslinker is typically present in an amount of 1% by weight to 5% by weight based one the weight of the fluoropolymer in the composition or first composition. In some embodiments, the crosslinker is present in a range from 1% by weight to 4% by weight based on the weight of the fluoropolymer in the composition or first composition. The benzoyl peroxide is present in the composition at a weight percent greater than or equal to that of the crosslinker.

Compositions according to the present disclosure and/or useful in the articles of the present disclosure can be prepared by compounding fluoropolymer, peroxide, and the crosslinker described above. Compounding can be carried out, for example, on a roll mill (e.g., two-roll mill), internal mixer (e.g., Banbury mixers), or other rubber-mixing device. Thorough mixing is typically desirable to distribute the components and additives uniformly throughout the composition so that it can cure effectively. It is typically desirable that the temperature of the composition during mixing should not rise high enough to initiate curing. For example, the temperature of the composition may be kept at or below about 50° C.

Additives such as carbon black, stabilizers, plasticizers, lubricants, fillers, and processing aids typically utilized in fluoropolymer compounding can be incorporated into the composition of the present disclosure and/or useful in the article and method of the present disclosure, provided they have adequate stability for the intended service conditions. In particular, low temperature performance can be enhanced by incorporation of perfluoropolyethers. See, for example, U.S. Pat. No. 5,268,405 to Ojakaar et al. In some embodiments, the composition includes carbon black. Carbon black fillers can be employed in fluoropolymers as a means to balance modulus, tensile strength, elongation, hardness, abrasion resistance, conductivity, and processability of the compositions. Suitable examples include MT blacks (medium thermal black) and large particle size furnace blacks. When used, 1 to 100 parts filler per hundred parts fluoropolymer (phr) of large size particle black is generally sufficient.

Fluoropolymer fillers may also be present in the composition of the present disclosure and/or useful in the article and method of the present disclosure. Generally, from 1 to 100 phr of fluoropolymer filler can be useful. The fluoropolymer filler can be finely divided and easily dispersed as a solid at the highest temperature used in fabrication and curing of the composition disclosed herein. By solid, it is meant that the filler material, if partially crystalline, will have a crystalline melting temperature above the processing temperature(s) of the curable composition(s). One way to incorporate fluoropolymer filler is by blending latices. This procedure, using various kinds of fluoropolymer filler, is described in U.S. Pat. No. 6,720,360 (Grootaert et al.).

Conventional adjuvants may also be incorporated into the composition of the present disclosure and/or useful in the article and method of the present disclosure to enhance the properties of the composition. For example, acid acceptors may be employed to facilitate the cure and thermal stability of the composition. Suitable acid acceptors may include magnesium oxide, lead oxide, calcium oxide, calcium hydroxide, dibasic lead phosphite, zinc oxide, barium carbonate, strontium hydroxide, calcium carbonate, hydrotalcite, alkali stearates, magnesium oxalate, or combinations thereof. The acid acceptors can be used in amounts ranging from about 1 to about 20 parts per 100 parts by weight of the fluoropolymer in the composition.

It can be useful to deliver amorphous fluoropolymers out of solvent to make cured fluoroelastomers. For example, uncured amorphous fluoropolymers, sometimes referred to as fluoroelastomer gums, can be dissolved in solvent and coated on a substrate. The typical amorphous fluoropolymer content of these solutions can be from 20% to 50% by weight versus the weight of the solution. Higher fluoropolymer content in these solutions (for example, at least 60% by weight fluoropolymer) may be desirable to increase coating thickness and to reduce volatile organic compounds (VOCs). In some embodiments, for example, for avoiding VOCs, to promote curing, and/or when low viscosity amorphous fluoropolymers are used, the composition of the present disclosure and/or useful in the article or method of the present disclosure can have less than 40, 35, 30, 25, 20, 15, 10, 5, or 1 percent solvent, based on the total weight of the composition. In some embodiments, the composition of the present disclosure and/or useful in the article or method of the present disclosure can have less than 40, 35, 30, 25, 20, 15, 10, 5, or 1 percent solvent having a solubility parameter in a range from 9.6 (MPa)^{1/2} to 26 (MPa)^{1/2}, based on the total weight of the composition. In some embodiments, the composition of the present disclosure and/or useful in the article or method of the present disclosure can have less than 40, 35, 30, 25, 20, 15, 10, 5, or 1 percent ketones or acetates, based on the total weight of the composition. In some embodiments, the composition of the present disclosure and/or useful in the article or method of the present disclosure can have less than 40, 35, 30, 25, 20, 15, 10, 5, or 1 percent butyl acetate, based on the total weight of the composition.

The composition of the present disclosure can be used to make cured fluoroelastomers in the form of a variety of articles, including final articles, such as O-rings, and/or preforms from which a final shape is made, (e.g. a tube from which a ring is cut). To form an article, the composition can be extruded using a screw type extruder or a piston extruder. The extruded or pre-formed compositions can be cured in an oven at ambient pressure.

Alternatively, the composition can be shaped into an article using injection molding, transfer molding, or compression molding. Injection molding of the composition, for example, can be carried out by masticating the curable composition in an extruder screw, collecting it in a heated chamber from which it is injected into a hollow mold cavity by means of a hydraulic piston. After curing, the article can then be demolded. Advantages of injection molding process include short molding cycles, little or no preform preparation, little or no flash to remove, and low scrap rate. The composition of the present disclosure and/or useful in the article and method of the present disclosure can also be used to prepare cure-in-place gaskets (CIPG) or form-in-place gaskets (FIPG). A bead or thread of the composition can be deposited from a nozzle onto a substrates surface. After forming to a desired gasket pattern, the composition may be cured in place with a heat or in an oven at ambient pressure.

The composition of the present disclosure and/or useful in the article and method can also be useful as a fluoroelastomer caulk, which can be useful, for example, to fill voids in, coat, adhere to, seal, and protect various substrates from chemical permeation, corrosion, and abrasion, for example. Fluoroelastomer caulk can be useful as a joint sealant for steel or concrete containers, seals for flue duct expansion joints, door gaskets sealants for industrial ovens, fuel cell sealants or gaskets, and adhesives for bonding fluoroelastomer gaskets (e.g., to metal). In some embodiments, the composition can be dispensed by hand and cured with heat at ambient pressure.

In some embodiments of the method of the present disclosure, heating the composition is carried out in an environment set above 100° C. In some embodiments, heating the composition is carried out in an environment set in a range from 120° C. to 180° C. In some embodiments, heating the composition is carried out in an environment set to a temperature of at least 180° C. The cure time can be at least 5, 10, 15, 20, or 30 minutes up to 24 hours, depending on the composition of the amorphous fluoropolymer and the cross-sectional thickness of the cured article.

The cured fluoroelastomer can be post-cured, for example, in an environment (e.g., oven) set at a temperature of about 120° C. to 300° C., in some embodiments, at a temperature of about 150° C. to 250° C., or at a temperature of at least 180° C. and/or less than 250° C. for a period of about 30 minutes to about 24 hours or more, depending on the chemical composition of the fluoroelastomer and the cross-sectional thickness of the sample.

As described above, the beneficial properties of fluoropolymers include high temperature resistance, chemical resistance (e.g., resistance to solvents, fuels, and corrosive chemicals), and non-flammability. At least because of these beneficial properties, fluoropolymers find wide application particularly where materials are exposed to high temperatures or aggressive chemicals. For example, because of their excellent resistance to fuels and their good barrier properties, fluoropolymers are commonly used in fuel management systems including fuel tanks, and fuel lines (e.g., fuel filler lines and fuel supply lines).

Typically, and unexpectedly, as shown in the Examples, below, fluoroelastomers prepared from the compositions having a relatively high amount of benzoyl peroxide have significantly improved compression sets compared to fluoroelastomers prepared from compositions having lower levels of benzoyl peroxide or 2,5-dimethyl-2,5-di(t-butylperoxy)-hexane. In some embodiments, the article of the present disclosure has a compression set of less than that of a comparative article, wherein the comparative article is the same as the article except that it was prepared from a composition in which the benzoyl peroxide was present at a weight percent less than that of the crosslinker.

### Some Embodiments of the Disclosure

In a first embodiment, the present disclosure provides a composition comprising:
a fluoropolymer having at least one of bromo- or iodo- cure sites;
a crosslinker comprising more than one carbon-carbon double bond; and
benzoyl peroxide in an amount of three to four parts per hundred parts of fluoropolymer in the composition, wherein the benzoyl peroxide is present in an amount greater than or equal to that of the crosslinker,
   wherein at least one of the following limitations is met:
the fluoropolymer is semi-crystalline;
the fluoropolymer has a Mooney viscosity (ML 1+10) at 100° C. of greater than 2.1; or
wherein the composition further comprises carbon black.

In a second embodiment, the present disclosure provides the composition of the first embodiment, wherein the amorphous fluoropolymer has the Mooney viscosity (ML 1+10) at 100° C. of greater than 2.1.

In a third embodiment, the present disclosure provides the composition of the first or second embodiment, wherein the composition has less than 20, 15, 10, 5, or one percent by weight solvent, based on the total weight of the composition.

In a fourth embodiment, the present disclosure provides the composition of any one of the first to third embodiments, wherein the composition has less than 20, 15, 10, 5, or one percent by weight butyl acetate, based on the total weight of the composition.

In a fifth embodiment, the present disclosure provides the composition of any one of the first to fourth embodiments, wherein the crosslinker comprises at least one of tri(methyl)allyl isocyanurate, triallyl isocyanurate, tri(methyl)allyl cyanurate, poly-triallyl isocyanurate, xylylene-bis(diallyl isocyanurate), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, or CH₂═CH—R_{f1}—CH═CH₂ wherein R_{f1} is a perfluoroalkylene having from 1 to 8 carbon atoms.

In a sixth embodiment, the present disclosure provides the composition of any one of the first to fifth embodiments, wherein the crosslinker comprises at least one of tri(methyl)allyl isocyanurate, triallyl isocyanurate, or xylylene-bis(diallyl isocyanurate).

In a seventh embodiment, the present disclosure provides the composition of any one of the first to sixth embodiments, wherein the fluoropolymer comprises an iodo-cure site.

In an eighth embodiment, the present disclosure provides the composition of any one of the first to seventh embodiments, wherein the fluoropolymer comprises interpolymerized units of at least one of a perfluorinated olefin represented by formula CF₂═CF—Rf, where Rf is fluorine or a perfluoroalkyl having 1 to 8 carbon atoms, a perfluoroalkyl vinyl ether, a perfluoroalkoxyalkyl vinyl ether, a perfluoroalkyl allyl ether, a perfluoroalkoxyalkyl allyl ether, or a partially fluorinated olefin.

In a ninth embodiment, the present disclosure provides the composition or of any one of the first to eighth embodiments, wherein the fluoropolymer comprises interpolymerized units of at least one of tetrafluoroethylene, hexafluoropropylene, trifluorochloroethylene, 2-chloropentafluoropropene, dichlorodifluoroethylene, vinylidene fluoride, vinyl fluoride, pentafluoropropylene, trifluoroethylene, perfluoromethyl vinyl ether, perfluoropropylvinyl ether, or CF₂═CFO(CF₂)₃OCF₃.

In a tenth embodiment, the present disclosure provides the composition of any one of the first to the ninth embodiments, further comprising filler.

In an eleventh embodiment, the present disclosure provides the composition of any one of the first to tenth embodiments, wherein the composition further comprises the carbon black.

In a twelfth embodiment, the present disclosure provides the composition of the eleventh embodiment, wherein the carbon black comprises at least one of a medium thermal black or a large-particle-size furnace blacks.

In a thirteenth embodiment, the present disclosure provides the composition of any one of the first to twelfth embodiment, wherein the benzoyl peroxide is present in an amount greater than that of the crosslinker

In a fourteenth embodiment, the present disclosure provides the composition of any one of the first to thirteenth embodiments, wherein the amount of the benzoyl peroxide is at least 1.1 times the amount of the crosslinker.

In a fifteenth embodiment, the present disclosure provides the composition of any one of the first to fourteenth embodiments, wherein the fluoropolymer has a Mooney viscosity (ML 1+10) at 121° C. of up to 100.

In a sixteenth embodiment, the present disclosure provides the composition of any one of the first to fifteenth embodiments, wherein the fluoropolymer has a Mooney viscosity (ML 1+10) at 121° C. in a range from 15 to 60.

In a seventeenth embodiment, the present disclosure provides the composition of any one of the first to sixteenth embodiments, wherein the fluoropolymer has a Mooney viscosity (ML 1+10) at 121° C. in a range from 20 to 50.

In an eighteenth embodiment, the present disclosure provides the composition of any one of the first to seventeenth embodiments, wherein the weight ratio of the benzoyl peroxide to the at least one of bromine to iodine cure sites is in a range from 3 to 40.

In a nineteenth embodiment, the present disclosure provides an article made by curing the composition of any one of the first to eighteenth embodiments.

In a twentieth embodiment, the present disclosure provides the article of the nineteenth embodiment, having a compression set of less than that of a comparative article, wherein the comparative article is the same as the article except that it was prepared from a composition in which the benzoyl peroxide was present at a weight percent less than that of the crosslinker. In a twenty-first embodiment, the present disclosure provides the article of the nineteenth or twentieth embodiment, having a compression set of less than that of a comparative article, wherein the comparative article is the same as the article except that it was prepared from a composition in which the benzoyl peroxide was replaced with 2,5-dimethyl-2,5-di(t-butylperoxy)-hexane (DBPH).

In a twenty-second embodiment, the present disclosure provides the article of any one of the nineteenth to twenty-first embodiments, wherein the article is a hose, an O-ring, a seal, a diaphragm, a valve, or a container.

In a twenty-third embodiment, the present disclosure provides a method of making a cured fluoroelastomer, the method comprising:
providing the composition of any one of the first to the seventeenth embodiments, and heating the composition to make the cured fluoroelastomer.

In a twenty-fourth embodiment, the present disclosure provides the method of the twenty-third embodiment, wherein heating the composition is carried out in an environment set to a temperature of at least 180° C.

In a twenty-fifth embodiment, the present disclosure provides the method of the twenty-third or twenty-fourth embodiment, wherein heating the composition is carried out in an environment set to a temperature of up to 250° C.

The following specific, but non-limiting, examples will serve to illustrate the present disclosure.

### EXAMPLES

Unless otherwise noted, all parts, percentages, ratios, etc. in the examples and the rest of the specification are by weight, and all reagents used in the examples were obtained, or are available, from general chemical suppliers such as, for example, MilliporeSigma Company, Saint Louis, Mo., or may be synthesized by conventional methods.

These abbreviations are used in the following examples: phr=parts per hundred rubber; g=grams, min=minutes, hr=hour, ° C.=degrees Celsius, MPa=megapascals, hz=hertz, and dNm=deci Newton-meter, PSI=pounds per square inch.

TABLE 1
Materials

| | |
|---|---|
| Polymer 1 | A fluoroelastomer derived from about 11% of TFE, 51% of VDF and 38% of |
| | perfluoromethyl vinylether (PMVE) CF₂ = CFOCF₃ by weight with 0.3% of iodine, |
| | 64.3% fluorine content, and Mooney viscosity ML1 + 10 @ 121° C. of 20. |
| Polymer 2 | A fluoroelastomer derived from about 12% of TFE, 34% of HFP and 54% of VDF |
| | by weight with 0.3% of iodine by weight, 67.3 wt % fluorine content, and Mooney |
| | viscosity ML 1 + 10 @ 121° C. of 20. |
| Polymer 3 | A fluoroelastomer derived from about 16% of TFE, 31% of VDF and 53% of |
| | CF₂ = CFO(CF₂)₃OCF₃ by weight with 0.12% of bromine, 67.1% fluorine content, |
| | and Mooney viscosity ML1 + 10 @, 121° C. of 95. |
| Carbon | N990 Carbon black commercially available from Cancarb Ltd, Medicine Hat, Alta., |
| Black | Canada. N550 and N330 Carbon black commercially available from Tokai Carbon |
| | CB, Fort Worth, TX. |
| Crosslinker | TAIC (triallyl isocyanurate) commercially available under the trade designation |
| 1 | “TAIC” from Nippon Kasei Chemical Co. Ltd., Tokyo, Japan |
| Crosslinker | XBD, xylylene-bis(diallyl isocyanurate) obtained from Nippon Kasei Chemical Co. |
| 2 | Ltd., Tokyo, Japan |
| Peroxide 1 | 2,5-dimethyl-2,5-di(t-butylperoxy)-hexane, 50% active, available under the trade |
| | designation “VAROX DBPH-50” from Vanderbilt Chemicals, LLC., Norwalk, CT. |
| Peroxide 2 | Benzoyl Peroxide, 98% active, available from Sigma Aldrich |

### Cure Rheology

Cure rheology tests were carried out using uncured, compounded samples using a rheometer marketed under the trade designation MDR 2000 by Alpha technologies, Hudson, Ohio, in accordance with ASTM D 5289-93a at 177° C., no pre-heat, 12-minute elapsed time, and a 0.5 degree arc. Both the minimum torque (M_{L}) and highest torque attained during a specified period of time when no plateau or maximum torque (M_{H}) was obtained were measured. Also measured were the time for the torque to reach a value equal to M_{L}+0.1(M_{H}−M_{L}), (t′10), the time for the torque to reach a value equal to M_{L}+0.5(M_{H}−M_{L}), (t′50), and the time for the torque to reach M_{L}+0.9(M_{H}−M_{L}), (t′90). Results are reported in Tables 2 through 7.

### Molding, Tensile, and Compression Set

O-rings (214, AMS AS568) and sheets having a thickness of 2.0 mm were molded and press cured, followed by a postcure as noted in the table. The dumbbell specimens were cutout from the sheets and subjected to physical property testing similar to the procedure disclosed in ASTM D412-06a (2013). The O-rings were subjected to compression set testing similar to the procedure disclosed in ASTM D 395-03 Method B and ASTM D 1414-94, with 25% initial deflection. Results are reported in Tables 2 through 7.

### Compounding

200 g batches of polymers 1 to 3 were compounded with carbon blacks, 3 phr of Coagent 1 or 2, and various amounts of peroxides, on a two-roll mill.

TABLE 2

| | CE1 | CE2 | CE3 | CE4 |
|---|---|---|---|---|
| Example | | | | |
| Polymer 1 | 100 | 100 | 100 | 100 |
| N990 | 30 | 30 | 30 | 30 |
| Crosslinker 1 | 3 | 3 | 3 | 3 |
| Peroxide 1 | 1 | 2 | 3 | 4 |
| M_{L}, Minimum Torque, dNm | 0.2 | 0.2 | 0.2 | 0.3 |
| M_{H}, Maximum Torque, dNm | 21.5 | 21.7 | 21.5 | 21.4 |
| t′50, Time to | 1.2 | 0.7 | 0.6 | 0.5 |
| 50% cure - minutes | | | | |
| t′90, Time to | 2.9 | 1.3 | 1.0 | 0.7 |
| 90% cure - minutes | | | | |
| Post Cure 250° | | | | |
| C., 16 hours | | | | |
| Tensile strength | 18.4 | 16.1 | 19.0 | 17.0 |
| at break, MPa | | | | |
| Elongation at break, % | 239 | 252 | 273 | 206 |
| 100% Modulus, MPa | 2.3 | 2.6 | 3.0 | 3.4 |
| Hardness, Shore A | 64 | 63 | 65 | 66 |
| Compression Set 70 hours | | | | |
| 200° C., 25% deflection | | | | |
| post cure | 38 | 35 | 33 | 33 |
| Compression Set 70 hours | | | | |
| 232° C., 25% deflection | | | | |
| post cure | 75 | 74 | 74 | 75 |

TABLE 3

| | CE-5 | CE-6 | EX1 | EX2 |
|---|---|---|---|---|
| Example | | | | |
| Polymer 1 | 100 | 100 | 100 | 100 |
| N990 | 30 | 30 | 30 | 30 |
| Crosslinker 1 | 3 | 3 | 3 | 3 |
| Peroxide 2 | 1 | 2 | 3 | 4 |
| M_{L}, Minimum Torque, dNm | 0.9 | 0.9 | 0.8 | 0.8 |
| M_{H}, Maximum Torque, dNm | 3.3 | 17.5 | 21.5 | 21.9 |
| t′50, Time to | 2.0 | 1.9 | 1.3 | 1.0 |
| 50% cure - minutes | | | | |
| t′90, Time to | 4.0 | 4.4 | 3.0 | 2.2 |
| 90% cure - minutes | | | | |
| Post Cure 250° | | | | |
| C., 16 hours | | | | |
| Tensile strength | NT | 12.5 | 16.9 | 17.0 |
| at break, MPa | | | | |
| Elongation at break, % | NT | 412 | 284 | 263 |
| 100% Modulus, MPa | NT | 1.9 | 3.0 | 3.5 |
| Hardness, Shore A | NT | 64 | 65 | 65 |
| Compression Set 70 hours | | | | |
| 200° C., 25% deflection | | | | |
| post cure | NT | 45 | 23 | 26 |
| Compression Set 70 hours | | | | |
| 232° C., 25% deflection | | | | |
| post cure | NT | 79 | 57 | 59 |

NT = not tested

TABLE 4

| | CE7 | EX3 |
|---|---|---|
| Example | | |
| Polymer 2 | 100 | 100 |
| N990 | 30 | 30 |
| Crosslinker 1 | 3 | 3 |
| Peroxide 1 | 2 | |
| Peroxide 2 | | 4 |
| M_{L}, Minimum Torque, dNm | 0.3 | 0.8 |
| M_{H}, Maximum Torque, dNm | 23.7 | 23.3 |
| t′50, Time to | 0.8 | 1.1 |
| 50% cure - minutes | | |
| t′90, Time to | 1.6 | 2.7 |
| 90% cure - minutes | | |
| Post Cure 250° | | |
| C., 4 hours | | |
| Tensile strength | 23.3 | 15.3 |
| at break, MPa | | |
| Elongation at break, % | 239 | 215 |
| 100% Modulus, MPa | 4.6 | 5.1 |
| Hardness, Shore A | 69 | 70 |
| Compression Set 70 hours | | |
| 200° C., 25% deflection | | |
| post cure | 31 | 21 |
| Compression Set 70 hours | | |
| 232° C., 25% deflection | | |
| post cure | 61 | 51 |

TABLE 5

| | CE-8 | EX-4 | CE-9 | CE-10 |
|---|---|---|---|---|
| Example | | | | |
| Polymer 2 | 100 | 100 | 100 | 100 |
| N550 | 12.5 | 12.5 | | |
| N330 | | | 12 | 12 |
| Crosslinker 1 | 3 | 3 | 3 | 3 |
| Peroxide 1 | 2 | | 2 | |
| Peroxide 2 | | 4 | | 4 |
| M_{L}, Minimum Torque, dNm | 0.3 | 0.8 | 0.3 | 0.8 |
| M_{H}, Maximum Torque, dNm | 20.8 | 18.4 | 20.7 | 7.7 |
| t′50, Time to | 0.9 | 1.4 | 1.1 | 1.7 |
| 50% cure - minutes | | | | |
| t′90, Time to | 1.5 | 3.4 | 2.1 | 3.4 |
| 90% cure - minutes | | | | |
| Post Cure 250° | | | | |
| C., 16 hours | | | | |
| Tensile strength | 23.7 | 22.6 | 22.9 | 16.4 |
| at break, MPa | | | | |
| Elongation at break, % | 250 | 269 | 235 | 391 |
| 100% Modulus, MPa | 3.3 | 3.3 | 3.1 | 1.9 |
| Hardness, Shore A | 65 | 65 | 65 | 62 |
| Compression Set 70 hours | | | | |
| 200° C., 25% deflection | | | | |
| post cure | 30 | 30 | 30 | 59 |
| Compression Set 70 hours | | | | |
| 232° C., 25% deflection | | | | |
| post cure | 63 | 63 | 62 | 81 |

TABLE 6

| | CE-11 | EX-5 |
|---|---|---|
| Example | | |
| Polymer 3 | 100 | 100 |
| N990 | 50 | 50 |
| Crosslinker 1 | 3 | 3 |
| Peroxide 1 | 2 | |
| Peroxide 2 | | 4 |
| ML, Minimum Torque, dNm | 4.0 | 4.9 |
| MH, Maximum Torque, dNm | 16.1 | 19.7 |
| t′50, Time to | 0.9 | 1.9 |
| 50% cure - minutes | | |
| t′90, Time to | 2.3 | 3.7 |
| 90% cure - minutes | | |
| Post Cure 232° | | |
| C., 16 hours | | |
| Tensile strength | 10.2 | 11.0 |
| at break, MPa | | |
| Elongation at break, % | 199 | 161 |
| 100% Modulus, MPa | 4.3 | 6.7 |
| Hardness, Shore A | 68 | 75 |
| Compression Set 70 hours | | |
| 200° C., 25% deflection | | |
| post cure | 47 | 43 |
| Compression Set 70 hours | | |
| 232° C., 25% deflection | | |
| post cure | 85 | 79 |

TABLE 7

| | CE-12 | EX-6 |
|---|---|---|
| Example | | |
| Polymer 3 | 100 | 100 |
| N990 | 50 | 50 |
| Crosslinker 2 | 3 | 3 |
| Peroxide 1 | 2 | |
| Peroxide 2 | | 4 |
| ML, Minimum Torque, dNm | 0.5 | 1.4 |
| MH, Maximum Torque, dNm | 18.2 | 20.5 |
| t′50, Time to | 0.7 | 1.0 |
| 50% cure - minutes | | |
| t′90, Time to | 1.3 | 2.6 |
| 90% cure - minutes | | |
| Post Cure 232° | | |
| C., 16 hours | | |
| Tensile strength | 18.0 | 20.9 |
| at break, MPa | | |
| Elongation at break, % | 278 | 259 |
| 100% Modulus, MPa | 3.6 | 4.5 |
| Hardness, Shore A | NM | NM |
| Compression Set 70 hours | | |
| 200° C., 25% deflection | | |
| post cure | 29 | 22 |

NM = not measured

Various modifications and alterations of this disclosure may be made by those skilled the art without departing from the scope and spirit of this disclosure, and it should be understood that this invention is not to be unduly limited to the illustrative embodiments set forth herein.

1. A composition comprising:
a fluoropolymer having at least one of bromo- or iodo-cure sites;
a crosslinker comprising more than one carbon-carbon double bond; and
benzoyl peroxide in an amount of three to four parts per hundred parts of fluoropolymer in the composition, wherein the benzoyl peroxide is present in an amount greater than or equal to that of the crosslinker,
wherein at least one of the following limitations is met:
the fluoropolymer has a Mooney viscosity (ML 1+10) at 100° C. of greater than 2.1; or
wherein the composition further comprises carbon black.

2. The composition of claim 1, wherein the benzoyl peroxide is present in an amount greater than that of the crosslinker.

3. The composition of claim 1, wherein the composition has less than one percent by weight butyl acetate, based on the total weight of the composition.

4. The composition of claim 1, wherein the crosslinker comprises at least one of tri(methyl)allyl isocyanurate, triallyl isocyanurate, tri(methyl)allyl cyanurate, poly-triallyl isocyanurate, xylylene-bis(diallyl isocyanurate), N,N′-m-phenylene bismaleimide, diallyl phthalate, tris(diallylamine)-s-triazine, triallyl phosphite, 1,2-polybutadiene, ethyleneglycol diacrylate, diethyleneglycol diacrylate, or CH₂═CH—R_{f1}—CH═CH₂ wherein R_{f1} is a perfluoroalkylene having from 1 to 8 carbon atoms.

5. The composition of claim 4, wherein the crosslinker comprises at least one of tri(methyl)allyl isocyanurate, triallyl isocyanurate, or xylylene-bis(diallyl isocyanurate).

6. The composition of claim 1, wherein the fluoropolymer comprises an iodo-cure site.

7. The composition of claim 1, wherein the fluoropolymer comprises interpolymerized units of at least one of a perfluorinated olefin represented by formula CF₂═CF—Rf, where Rf is fluorine or a perfluoroalkyl having 1 to 8 carbon atoms, a perfluoroalkyl vinyl ether, a perfluoroalkoxyalkyl vinyl ether, a perfluoroalkyl allyl ether, a perfluoroalkoxyalkyl allyl ether, or a partially fluorinated olefin.

8. The composition of claim 1, wherein the fluoropolymer comprises interpolymerized units of at least one of tetrafluoroethylene, hexafluoropropylene, trifluorochloroethylene, 2-chloropentafluoropropene, dichlorodifluoroethylene, vinylidene fluoride, vinyl fluoride, pentafluoropropylene, trifluoroethylene, perfluoromethyl vinyl ether, perfluoropropylvinyl ether, or CF₂═CFO(CF₂)₃OCF₃.

9. The composition of claim 1, wherein the fluoropolymer has a Mooney viscosity (ML 1+10) at 121° C. of up to 100.

10. The composition of claim 1, wherein the weight ratio of the benzoyl peroxide to the at least one of bromine to iodine cure sites is in a range from 3 to 40.

11. An article made by curing the composition of claim 1.

12. The article of claim 11, having a compression set of less than that of a comparative article, wherein the comparative article is the same as the article except that it was prepared from a composition in which the benzoyl peroxide was present at a weight percent less than that of the crosslinker.

13. A method of making a cured fluoroelastomer, the method comprising:
providing the composition of claim 1, and
heating the composition to make the cured fluoroelastomer.

14. The method of claim 13, wherein heating the composition is carried out in an environment set to a temperature of at least 180° C.

15. The method of claim 12, wherein heating the composition is carried out in an environment set to a temperature of up to 250° C.

16. The composition of claim 1, wherein the carbon black comprises at least one of a medium thermal black or a large-particle-size furnace blacks.

17. The composition of claim 1, wherein the amount of the benzoyl peroxide is at least 1.1 times the amount of the crosslinker.
